(19) United States
(12) Patent Application Publication
(10) Pub. No.: US 2012/0050315 A1
(43) Pub. Date: Mar. 1, 2012

(54) SYSTEMS AND METHODS FOR TRANSFORMING AND/OR GENERATING A TANGIBLE PHYSICAL STRUCTURE BASED ON USER INPUT INFORMATION

(76) Inventor: Janos Stone, Astoria, NY (US)

(21) Appl. No.: 12/862,190

(22) Filed: Aug. 24, 2010

(51) Int. Cl. G09G 5/00

(52) U.S. Cl. 345/619

(57) ABSTRACT

Systems and methods that can transform and/or generate a virtual object having first configuration to a virtual object having a second configuration based on alpha-numeric information input by a user. The virtual object can be transformed from a first configuration to a second configuration by a physical and/or virtual object transforming system “object transforming system” using an algorithm based on alpha-numeric information input by the user, shape transformation information, and/or color transformation information. In a second configuration, the virtual object can then be transformed into a tangible physical object using a tangible physical object generating system “object generating system” and/or can be used as an identification

### FIELD

The present invention relates to systems and methods for transforming a virtual object.

### SUMMARY

In exemplary embodiments, a method for transforming an object based on user input information can comprise receiving a user input alpha-numeric input information; storing, in at least one processor readable memory, the user input alpha-numeric input information and correlating, using an algorithm, the user input alpha-numeric information with at least one of shape and color transformations; and processing, using at least one processor, the alpha-numeric inputs and the algorithm to transform at least one of the shape and the color of the virtual object from a first configuration to a second configuration.

In exemplary embodiments, the method can further comprise generating, using at least one object generating system, a tangible physical object based on the second configuration of the virtual object.

In exemplary embodiments, the alpha-numeric input information can include the alpha-numeric letters A through Z of the Latin and/or Roman alphabet and/or the Arabic numerals 0 through 9.

In exemplary embodiments, the alpha-numeric input information can include alpha-numerical letters of any alphabet of any language such as, but not limited to, Greek, Russian, Hebrew, Japanese, and/or any other language.

In exemplary embodiments, each consecutive user input alpha-numeric input into the algorithm can cause consecutive transformations of the virtual object such that the previous transformation can be used in the next consecutive transformation. Further, the alpha-numeric information can be a user's name, identification, or any other marker.

In exemplary embodiments, the virtual object having a first shape can be cuboid, any three-dimensional shape capable of being manipulating using alpha-numeric inputs, and/or the three-dimensional shape can be that of a consumer product.

In exemplary embodiments, the tangible physical object can be generated using at least one of stereo-lithography, 3-D printing, and direct laser sintering.

In exemplary embodiments, the virtual object can be an avatar.

In exemplary embodiments, the new shaped physical object can be for an identifcation and/or pass code.

In exemplary embodiments, a system for transforming an object based on user input information can comprise a communications portal and/or a user interface for receiving a user input alpha-numeric input information; at least one processor readable memory for storing the user input alpha-numeric input information and for storing an algorithm that correlates the user input alpha-numeric input information to at least one of shape and color transformations; and at least one processor for accessing and processing the user input alpha-numeric input information and an algorithm for transforming at least one of the shape and color of the virtual object from a first configuration to a second configuration.

In exemplary embodiments, the system can further comprise at least one object generating system for generating a tangible physical object based on the second configuration of the virtual object.

In exemplary embodiments, the alpha-numeric input information can include the alpha-numeric letters A through Z of the Latin and/or Roman alphabet and/or the Arabic numerals 0 through 9.

In exemplary embodiments, each consecutive user input alpha-numeric input into the algorithm can cause consecutive transformations of the virtual object such that the previous transformation can be used in the next consecutive transformation. Further, the alpha-numeric input information can be a user's name.

In exemplary embodiments, the virtual object having a first shape can be cuboid, can be any three-dimensional shape capable of being manipulating using alpha-numeric inputs, and/or the three-dimensional shape can be that of a consumer product.

In exemplary embodiments, the at least one object generating system can further comprise a stereo-lithography machine; 3-D printing system; and/or direct metal laser sintering system.

In exemplary embodiments, the virtual object can be an avatar.

In exemplary embodiments, the new shaped physical object can be for at least one of an identification and pass code.

### BRIEF DESCRIPTION OF THE DRAWINGS

The features and advantages of the present invention will be more fully understood with reference to the following, detailed description when taken in conjunction with the accompanying figures, wherein:

FIG. 1 is a block diagram of certain components of the systems and methods for transforming and/or generating a tangible physical structure based on user input information, in accordance with exemplary embodiments of the present invention;

FIGS. 2A-2C are illustrative depictions of various shape changes and color changes affiliated with alpha-numeric values, in accordance with exemplary embodiments of the present invention;

FIG. 3 is a flow chart illustrating transforming and/or generating a tangible physical structure based on user input information, in accordance with exemplary embodiments of the present invention;

FIG. 4 is a flow chart illustrating transforming an object based on user input information, in accordance with exemplary embodiments of the present invention;

FIGS. 5A-6B are illustrative depictions of various steps of FIG. 4 illustrating transforming an object based on user input information, in accordance with exemplary embodiments of the present invention;

FIG. 7 illustratively depicts a mobile phone transforming, in accordance with exemplary embodiments of the present invention; and

FIG. 8 illustratively depicts an identification generating, in accordance with exemplary embodiments of the present invention.

### DETAILED DESCRIPTION

The invention generally relates to systems and methods that can transform and/or generate a virtual object in first configuration to a virtual object in a second configuration based on alpha-numeric information input by a user. The virtual object can be transformed from a first configuration to a second configuration by a physical and/or virtual object transforming system “object transforming system” using an algorithm that can affiliate shape transformations, color transformations, and alpha-numeric information to alpha-numeric information input by the user. In a second configuration, the virtual object can then be generated into a tangible physical object using a tangible physical object generating system “object generating system.”

In some instances, the virtual object may not be transformed into a physical object. For example, in a second configuration, the virtual object can remain as a virtual object that can be used as a pass code and/or identification (“identification”).

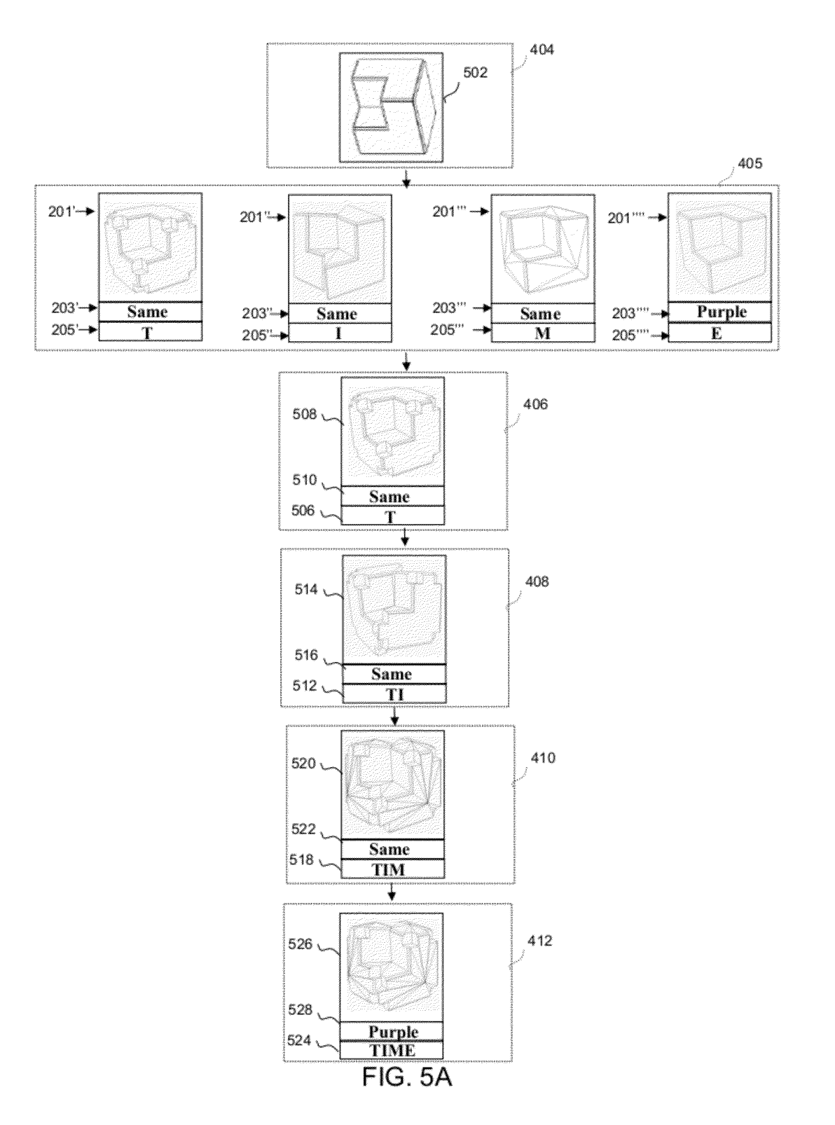

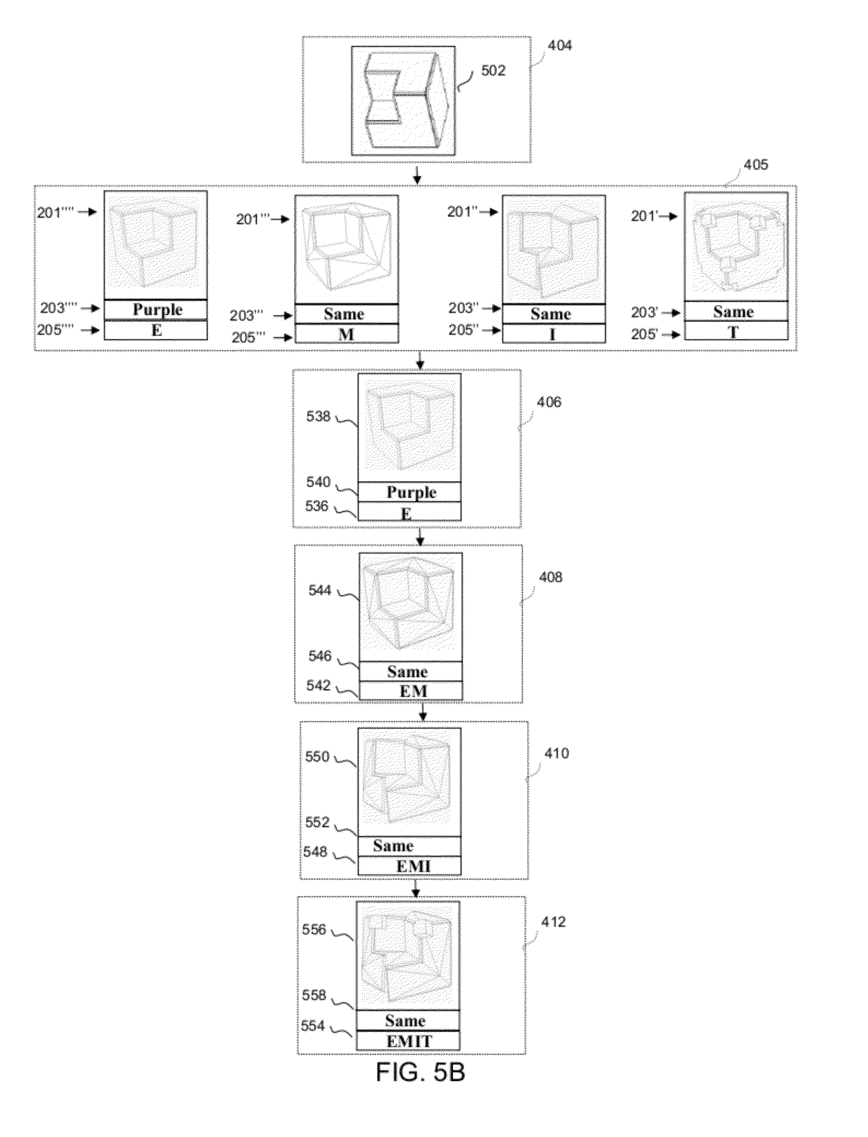

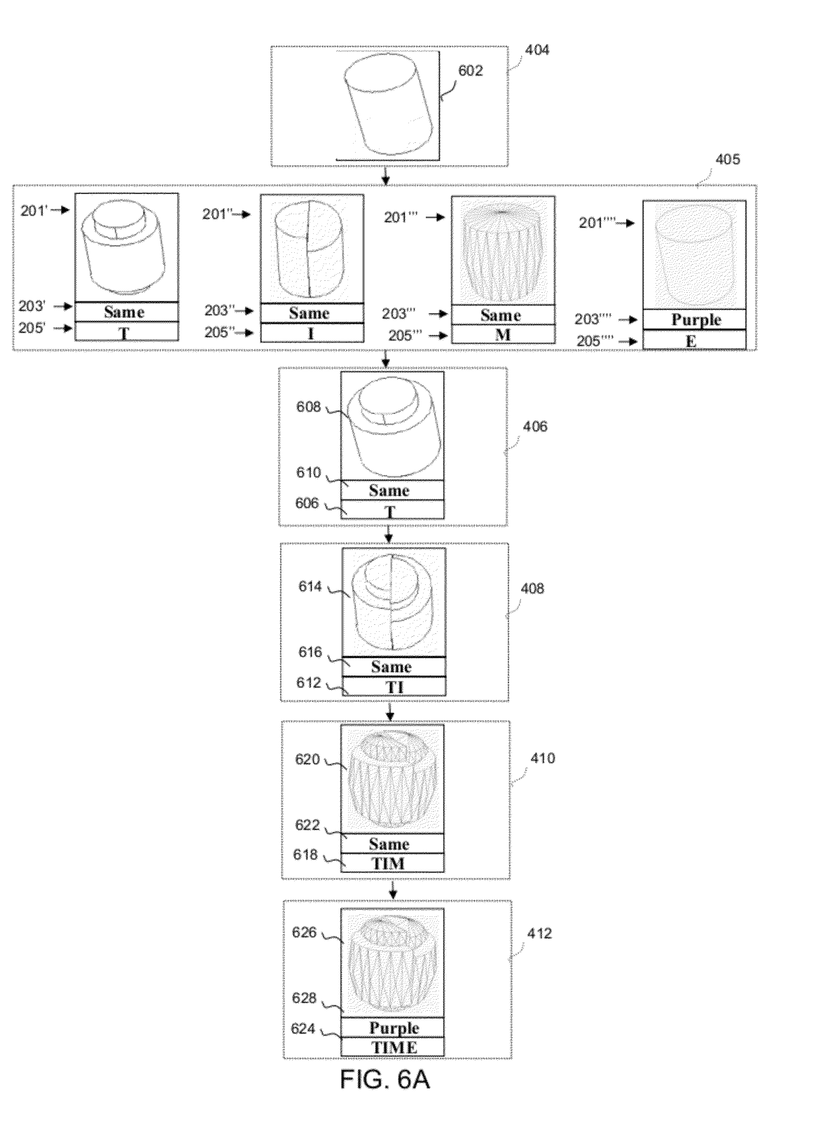

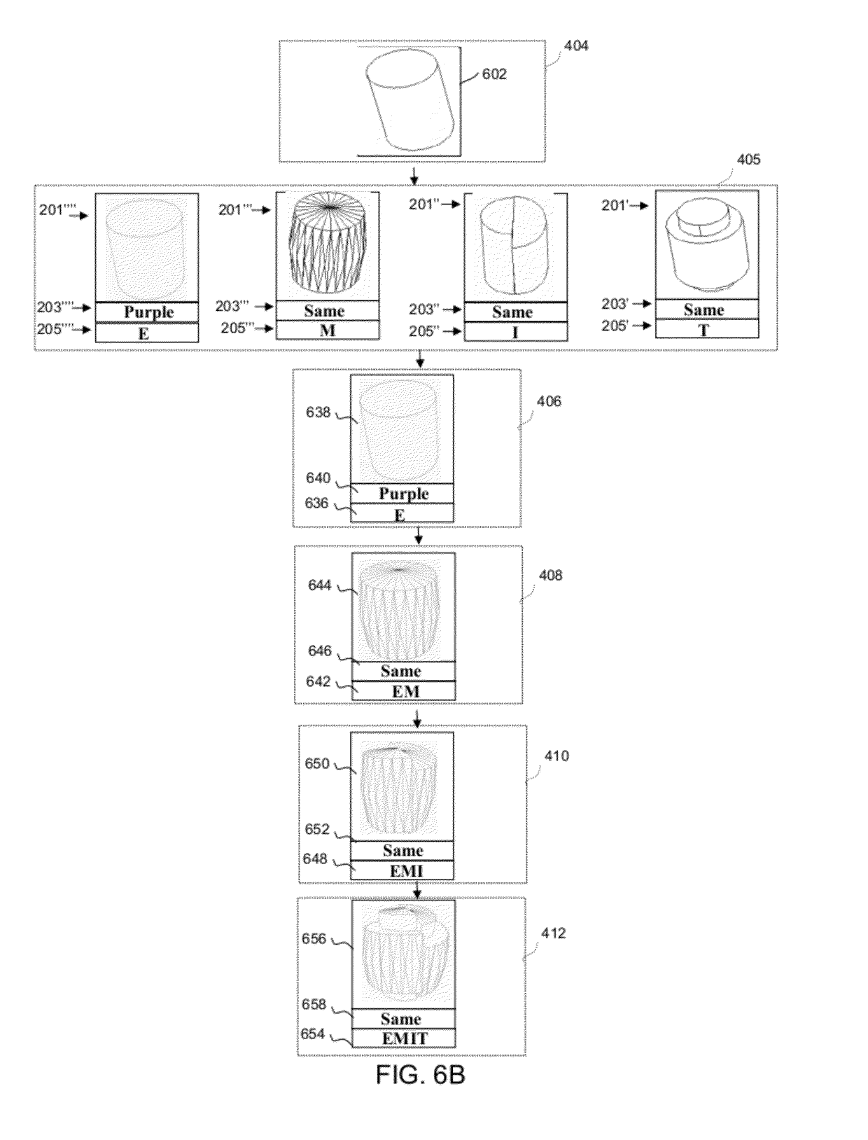

In exemplary embodiments, each alpha-numeric input can transform the shape and/or color of object such that the shape and/or color can sequentially and/or cumulatively transform based on previous inputs such that the order in which the alpha-numeric information is input can affect the shape of the object. For example, as illustrated in FIGS. 5A and 5B and in FIGS. 6A and 6B, inputting “T-I-M-E”, in some instances, may generate one shape while inputting “E-M-I-T” may generate a different shape.

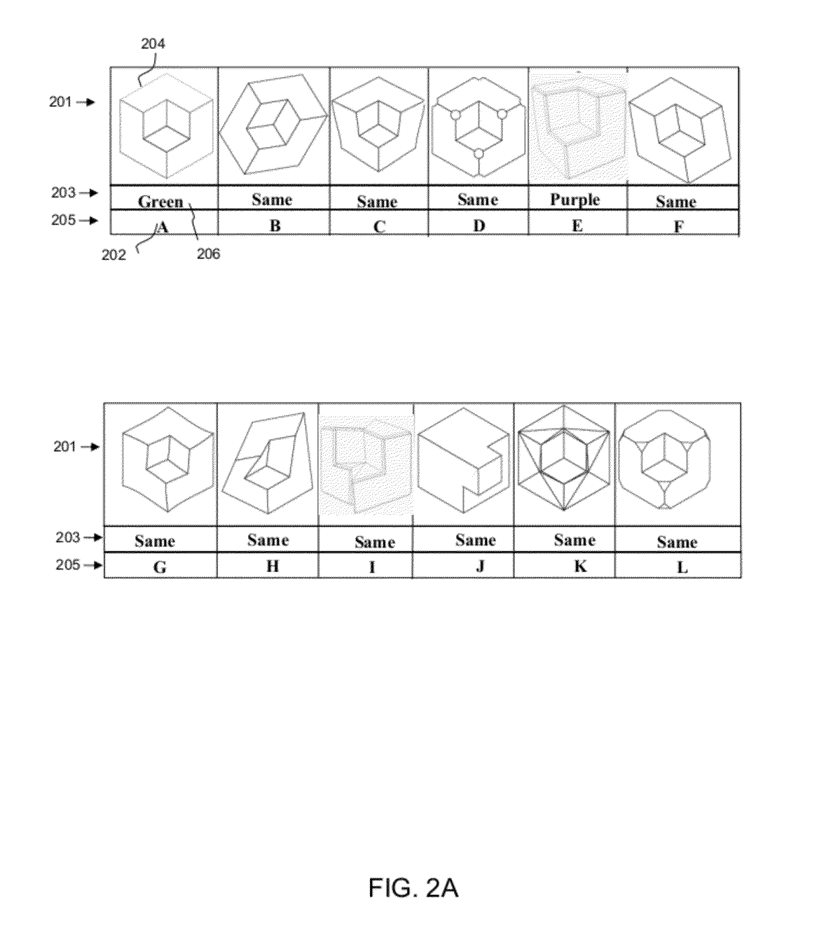

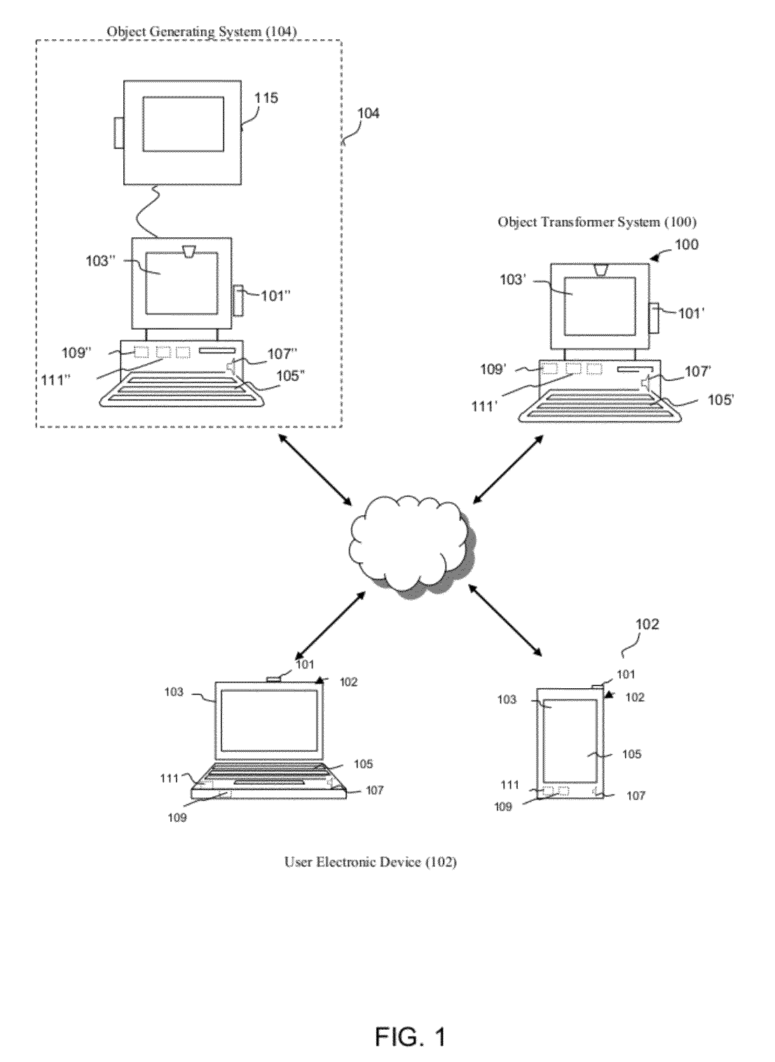

Referring to FIG. 1, object transforming system 100 can communicate at least some information affiliated with an object in a first configuration to a user, via user electronic device 102, and based on user input alpha-numeric information object transforming system 100 can transform the shape and/or color of the object to a second configuration such that object generating system 104 can produce a tangible physical object in the second configuration.

It will be understood that any of object transforming system 100, user electronic device 102, and/or physical object generating system 104 can communicate with each other and/or can be further combined and/or separated. For ease, object transforming system 100, user electronic device 102, and/or physical object generating system 104 are, at times, shown separately. This is merely for ease and is in no way meant to be a limitation.

Further, object transforming system 100 can reside on and/or be affiliated with user electronic device 102. For example, object transforming system 100 can be an algorithm stored in processor readable memory that can be accessed and/or processed by a processor affiliated with user electronic device 102. Further still, object transforming system 100 can reside on and/or be affiliated with physical object generating system 104. For example, object transforming system 100 can be an algorithm stored in processor readable memory that can be accessed and/or processed by a processor affiliated with physical object generating system 104.

As shown, object transforming system 100, user electronic device 102, and/or physical object generating system 104 can include, but is not limited to, at least one communication portal 101, 101′, 101″; at least one graphical user interface 103, 103′, 103″; at least one user input 105, 105′, 105″; at least one speaker 107, 107′, 107″; at least one processor readable memory 109, 109′, 109″; at least one processor 111, 111′, 111″; and any other reasonable components for use in communicating information (e.g., data), storing information, and processing any form of information.

In some instances, graphical user interface 103, 103′, 103″ and user input 105, 105′, 105″ can be substantially the same. For example, graphical user interface 103, 103′, 103″ and user input 105, 105′, 105″ can be combined as a touch distribution system. The touch distribution system can be a display that can detect the presence and location of a touch within the distribution system area.

Object transforming system 100, user electronic device 102, and/or physical object generating system 104 can be, for example, a mobile phone, computer, ipad, ipod, iphone, Smartphone, and blackberry, to name a few.

Object transforming system 100, user electronic device 102, and/or physical object generating system 104 can include a plurality of subsystems and/or libraries, such as, but not limited to, shape transformation library subsystem, color transformation library subsystem, alpha-numeric library subsystem, and user input alpha-numeric library subsystem. Shape transformation library subsystem can include any processor readable memory capable of storing information affiliated with shape transformation and/or being accessed by any processor. Color transformation library subsystem can include any processor readable memory capable of storing information affiliated with color transformations and/or being accessed by any processor. Alpha-numeric library subsystem can include any processor readable memory capable of storing information affiliated with alpha-numeric inputs and/or being accessed by any processor.

It will be understood that the any aspect of an object can be transformed, such as, but not limited to, shape, color, material properties, texture, mechanical properties, any combination thereof, and/or any aspect of the object can be transformed. Further, any combination of colors and/or color patterns can be combined. For ease, at times, only shape and/or a single color transformation is described. This is merely for ease and is in no way meant to be a limitation.

It will be understood that the alpha-numeric system can be based on Latin letters and Arabic digits and/or can be based on any writing system based on an alphabet, abjad, abugida, syllabary, logography and/or any other writing system and/or symbol affiliated with any language such as, but not limited to, English, Hebrew, Russian, Greek, Japanese, Chinese, and/or any other language and/or any numeral system such as, but not limited to, Roman numerals, Egyptian numerals, and/or any other numeral system. For ease, at times, only Latin letters and Arabic digits are described. This is merely for ease and is in no way meant to be a limitation.

In exemplary embodiments, object generating system 104 can be affiliated with and/or an element of a rapid production device 115 such as, but not limited to, a 3-D printing system, direct metal laser sintering system, selective laser sintering system (“SLS”), fused deposition modeling system (“FDM”), stereolithography system (“SLA”), laminated object manufacturing system (“LOM”), and/or any technique and/or system that can produce a tangible physical structure. This tangible physical object can be produced from any reasonable material, such as, but not limited to, thermoplastics, metals powders, eutectic metals, photopolymer, paper, titanium alloys, wood, plastics, polymers, and/or any other material capable of being used to produce a tangible physical object.

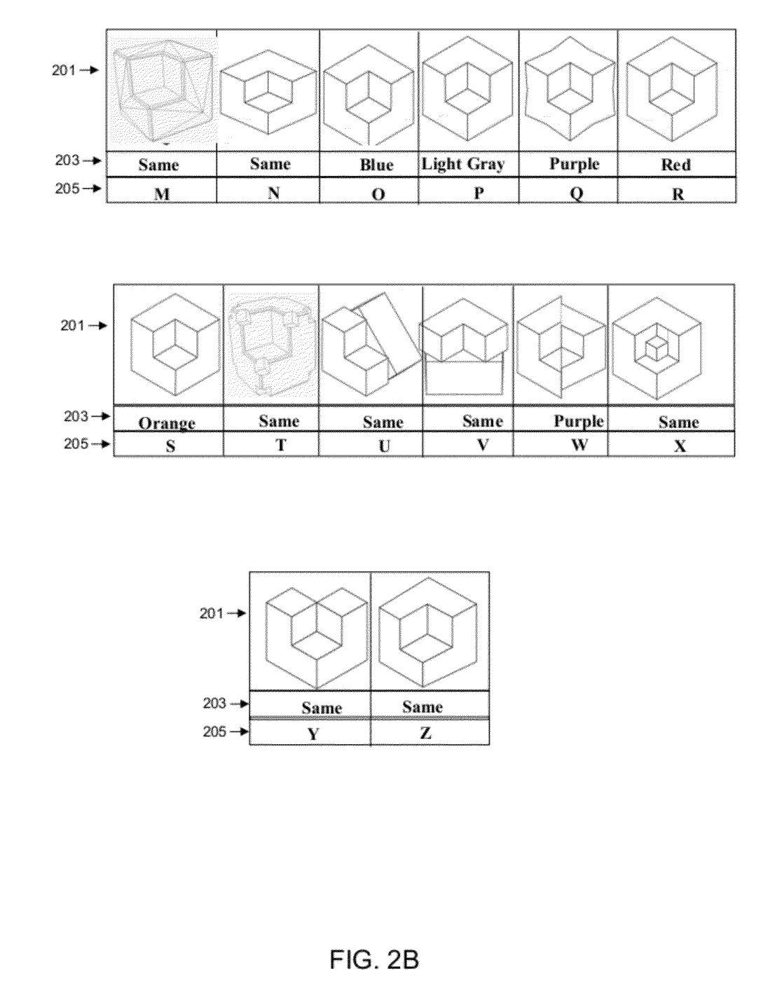

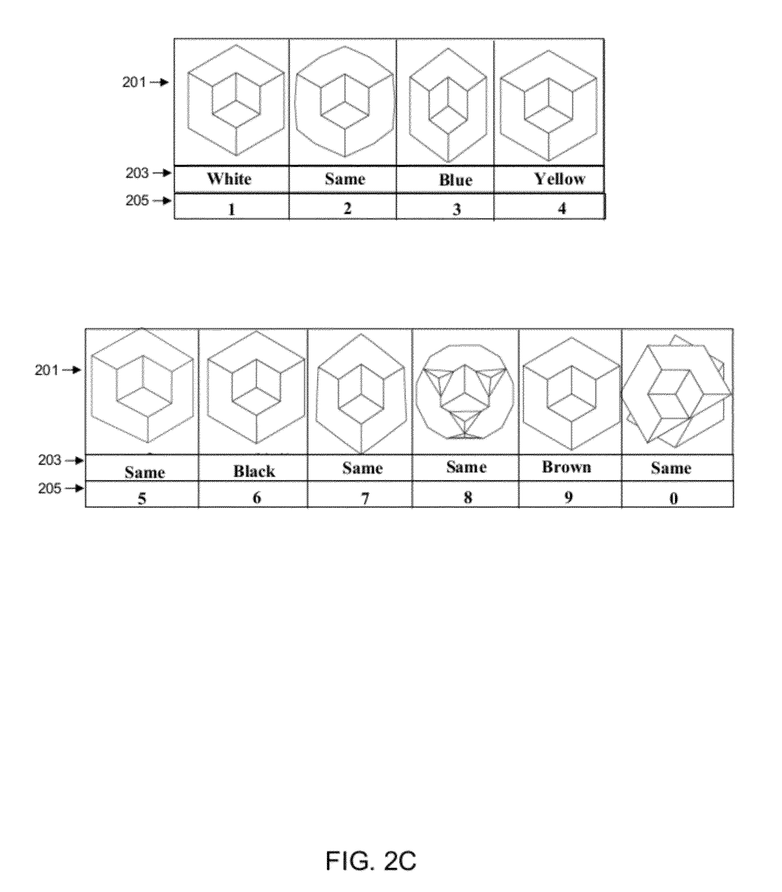

Referring to FIGS. 2A-2C, in exemplary embodiments, shape transformation information 201, color transformation information 203, and/or alpha-numeric information 205 can be affiliated with alpha-numeric information input by a user using, for example, an algorithm such that object transforming system 100 can transform the shape and/or color of an object based on alpha-numeric user inputs. By way of example, an algorithm can affiliate alpha-numeric information “A” 202 with shape transformation information 204 and color transformation information 203. Following this affiliation, when a user inputs alpha-numeric information “A” 202 the algorithm can cause the object's color to transformed to green and have the object's shape transformed to the shape depicted for shape transformation information 204.

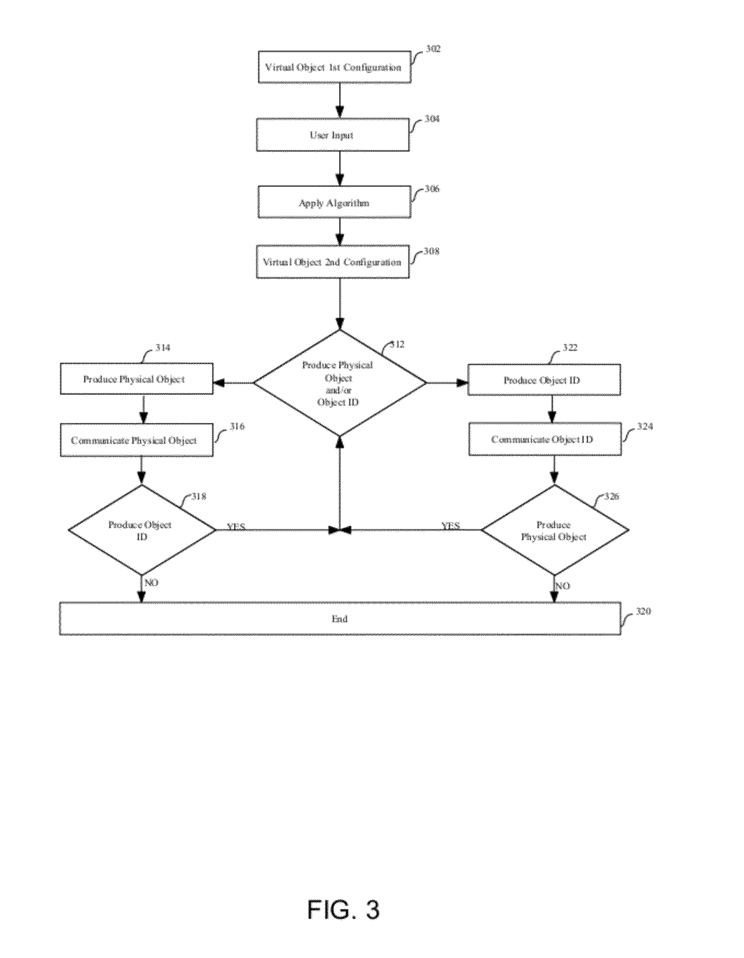

Referring to FIG. 3, in exemplary embodiments, a virtual object can be transformed from a first configuration to a second configuration and can be generated into a tangible physical object and/or into an object identification and/or pass code. For example, at step 302, at least some information affiliated with a virtual object in a first configuration can be stored in processor readable memory that can be accessed and/or processed by a processor affiliated with object transforming system 100 and at least some information affiliated with the virtual object can be transmitted via a communication portal to a user, via user device 102, and/or at least some information affiliated with a virtual object in a first configuration can be accessed by a user, via user device 102.

At step 304, a user can input a sequence of alpha-numeric inputs, such as, but not limited to, a persons name, a phrase, a word, a date, and/or any reasonable alpha-numeric input.

At step 306, an algorithm, stored in processor readable memory and/or capable of being accessed and/or processed by a processor, can affiliate various alpha-numeric information with various shape transformation information and/or various color transformation information such that based on the user's input sequence of alpha-numeric inputs the virtual object can transform from a first configuration to a second configuration. For example, the user's alpha-numeric inputs can be stored in a user input alpha-numeric input library and/or affiliated with stored information in alpha numeric input library 205, shape transformation library 201, and/or color transformation library 203 such that object transforming system 100 can access the stored user inputs and/or information causing the virtual object to transform from a first configuration to a second configuration.

At decision step 312, in a second configuration the virtual object can be produced as a tangible physical object, at step 314, and/or can be produced as a virtual object identification, at step 322. If a tangible physical object is desired, at step 314, object generating system 104 can generate the tangible physical object in the second configuration.

At step 316, the tangible physical object can be communicated and/or made available to a user such that the user can utilize the tangible physical object. At decision step 318, or decision step 312, the user can select to produce an object identification and/or pass code from the virtual object in the second configuration, at step 322.

The object identification can be any reasonable form of identification and/or pass code and can have encryption information affiliated with it. At step 324, the identification can be communicated and/or made available to a user such that the user can utilize the identification If the user has not already done so, similar to above, at decision step 326, or decision step 312, the user can select to generate the tangible physical object from the virtual object in the second configuration, at step 314. After producing the object identification and/or producing a tangible physical object the user can elect to quit and/or end the process, at step 320.

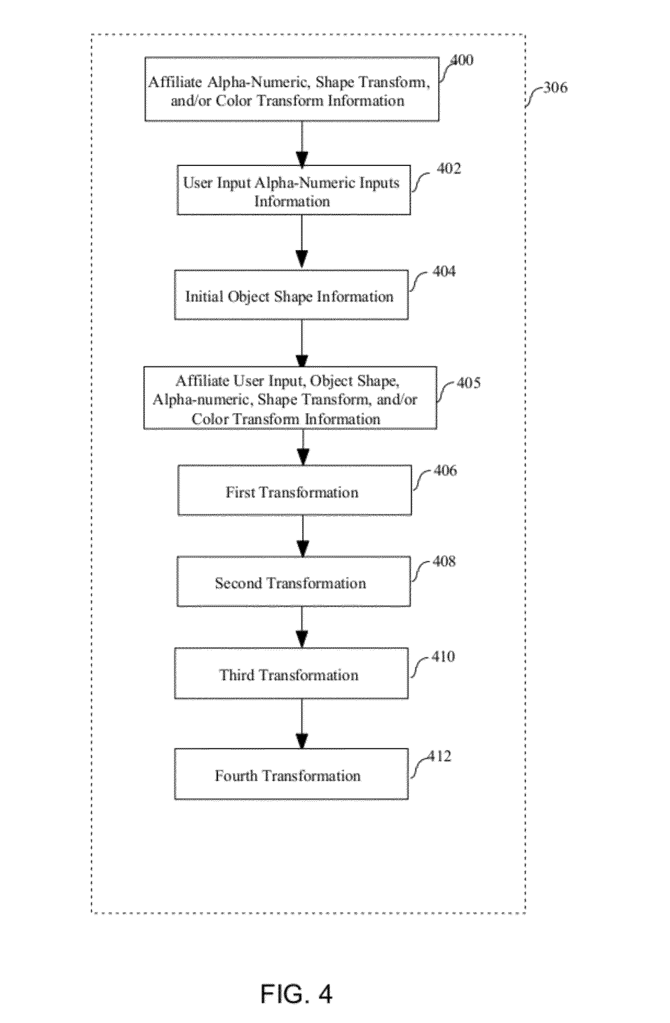

Referring to FIG. 4, in exemplary embodiments, an algorithm can be applied, at step 306 described above, that affiliates various alpha-numeric information with various shape transformation information and/or various color transformation information such that based on the user's alpha-numeric inputs the virtual object can transform from a first configuration to a second configuration.

More specifically, at step 400, an algorithm can be stored on at least one processor readable memory and/or can be accessed and/or processed by a processor affiliated with object transforming system 100, user electronic device 102, and/or object generating system 104, such that alpha-numeric information, shape transformation information, and/or various color transformation information can be used to affiliate user input alpha-numeric inputs to a shape and/or color transformation. For example, referring back to FIGS. 2A-2C, each shape transformation information 201, each color transformation information 203, and/or each alpha-numeric information 205 can be affiliated such that object transforming system 100 can use the affiliated information to change the shape and/or color of an object based on each sequential alpha-numeric inputs received from a user.

At step 402, each alpha-numeric user input can be stored in at least one processor readable memory and/or can be accessed and/or processed by at least one processor affiliated with object transforming system 100, user electronic device 102, and/or object generating system 104. By way of example, referring to FIGS. 5A and 6A, a user input alpha-numeric input phrase “T-I-M-E” and can be stored in at least one processor readable memory and/or can be accessed and/or processed by at least one processor affiliated with object transforming system 100 user electronic device 201, and/or object generating system 104. By way of another example, referring to FIGS. 5B and 6B, a user input alpha-numeric phrase “E-M-I-T” can be stored in at least one processor readable memory and /or can be accessed and/or processed by at least one processor affiliated with object transforming system 100, user electronic device 102, and/or object generating system 104.

At step 404 of FIG. 4, at least some information affiliated with an objects initial shape can be stored in at least one processor readable memory and/or can be accessed and/or processed by at least one processor. By way of example, referring to FIGS. 5A and 5B a cuboid shaped object 502, and referring to FIGS. 6A and 6B a cylindrical shaped object 602, can be stored in at least one processor readable memory such that it can be accessed and/or processed by at least one processor affiliated with object transforming system 100, user electronic device 102, and/or object generating system 104 at step 404. It will be understood that other shapes can be used. For ease, at times, not all variations of shapes are discussed. This is merely for ease and is in no way meant to be a limitation.

At step 405 of FIG. 4, in exemplary embodiments, at least some information affiliated with each of the user input alpha-numeric inputs, the object initial shape, and/or the affiliated alpha-numeric input, shape transformation, and/or color transformation, stored in at least one processor readable memory, can be accessed by at least one processor affiliated with object transforming system 100 such that each of the user's input alpha-numeric inputs can be affiliated with a shape transformation and/or color transformation for the object.

At steps 406-412 of FIG. 4, each of the user's input alpha-numeric inputs affiliated with shape transformations and/or color transformations for the object can be sequentially and/or cumulatively applied. For example, for four (4) alpha-numeric inputs, the first shape/color transformation can be the shape/color transformation for the first alpha-numeric input; the second shape/color transformation can be the shape/color transformation for the second alpha-numeric input applied against the result of the first shape/color transformation; the third shape/color transformation can be the shape/color transformation for the third alpha-numeric input applied against the result of the second shape/color transformation; and the fourth shape/color transformation can be the shape/color transformation for the fourth alpha-numeric input applied against the result of the third shape/color transformation.

By way of example, referring to FIG. 5A, for a user input alpha-numeric phrase “T-I-M-E” the first user input alpha-numeric input “T” 506, which affiliates with alpha-numeric information 205′ and color transformation 203′ and shape transformation 201′, causing shape transformation 508 and no color change 510 for the object (i.e., color remains the “same”), at step 406. The result of the first transformation can then undergo a second transformation based on the second user input alpha-numeric input “I” 512, which affiliates with alpha-numeric information 205″ and color transformation 203″ and shape transformation 201″, causing shape transformation 514 and no color change 516 for the object, at step 408. Next, the result of the second transformation can then undergo a third transformation based on the third user input alpha-numeric input “M” 518, which affiliates with alpha-numeric information 205″′, color transformation 203″′, and shape transformation 201″′, causing shape transformation 520 and no color change 522 for the object, at step 410. Lastly, the result of the third transformation can then undergo a fourth transformation based on the fourth user input alpha-numeric input “E” 524, which affiliates with alpha-numeric transformation 205″″, color transformation 203″″, and shape transformation 201″″, causing shape transformation 526 and color change 528 for the object, at step 412.

In exemplary embodiments, the order of the alpha-numeric inputs can effect the outcome of various transformations because, for example, the transformation can be cumulative. For example, the transformation of an object using a user input alpha-numeric phrase “T-I-M-E” may be different than a user input alpha-numeric phrase “E-M-I-T”.

By way of example, referring to FIG. 5B, for a user input alpha-numeric phrase “E-M-I-T” the first user input alpha-numeric input “E” 536, which affiliates with alpha-numeric transformation 205″″, color transformation 203″″, and shape transformation 201″″, causing shape transformation 538 and no color change 540 for the object, at step 406. The result of the first transformation can then undergo a second transformation based on the second user input alpha-numeric input “M”, which affiliates with alpha-numeric information 205″′, color transformation 203″′, and shape transformation 201″′, causing shape transformation 544 and no color change 546 for the object, at step 408. Next, the result of the second transformation can then undergo a third transformation based on the third user input alpha-numeric input “I”, which affiliates with alpha-numeric information 205″ and color transformation 203″ and shape transformation 201″, causing shape transformation 550 and no color change 552 for the object, at step 410. Lastly, the result of the third transformation can then undergo a fourth transformation based on the fourth user input alpha-numeric input “T” 554, which affiliates with alpha-numeric information 205′ and color transformation 203′ and shape transformation 201′, causing shape transformation 556 and color change 558 for the object, at step 412.

In exemplary embodiments, the shape of the initial object can be any geometric shape, such as, but not limited to, cuboid as shown in FIG. 5, columnar as shown in FIG. 6, and/or any reasonable geometric shape such as, but not limited to, polyhedronal, spherical, cylinder, conical, truncated cone, prisms, any combination or separation thereof, and/or any other geometric shape and/or any other reasonable shape.

In exemplary embodiments, the shape of the initial object can affect the outcome of various transformations. By way of example, referring to FIG. 6A, for a user input alpha-numeric phrase “T-I-M-E” the first user input alpha-numeric input “T” 606, which affiliates with alpha-numeric information 205′ and color transformation 203′ and shape transformation 201′, causing shape transformation 608 and no color change 610 for the object, at step 406. The result of the first transformation can then undergo a second transformation based on the second user input alpha-numeric input “I” 612, which affiliates with alpha-numeric information 205″ and color transformation 203″ and shape transformation 201″, causing shape transformation 614 and no color change 616 for the object, at step 408. Next, the result of the second transformation can then undergo a third transformation based on the third user input alpha-numeric input “M” 618, which affiliates with alpha-numeric information 205″′, color transformation 203″′, and shape transformation 201″′, causing shape transformation 620 and no color change 622 for the object, at step 410. Lastly, the result of the third transformation can then undergo a fourth transformation based on the fourth user input alpha-numeric input “E” 624, which affiliates with alpha-numeric transformation 205″″, color transformation 203″″, and shape transformation 201″″, causing shape transformation 626 and color change 628 for the object, at step 412.

Further, in exemplary embodiments, the shape and/or the order of the alpha-numeric inputs can effect the outcome of various transformations. By way of example, referring to FIG. 6B, for a user input alpha-numeric phrase “E-M-I-T” the first user input alpha-numeric input “E” 636, which affiliates with alpha-numeric transformation 205″″, color transformation 203″″, and shape transformation 201″″, causing shape transformation 638 and no color change 640 for the object, at step 406. The result of the first transformation can then undergo a second transformation based on the second user input alpha-numeric input “M” 642, which affiliates with alpha-numeric information 205″′, color transformation 203″′, and shape transformation 201″′, causing shape transformation 644 and no color change 646 for the object, at step 408. Next, the result of the second transformation can then undergo a third transformation based on the third user input alpha-numeric input “I” 648, which affiliates with alpha-numeric information 205″ and color transformation 203″ and shape transformation 201″, causing shape transformation 650 and no color change 652 for the object, at step 410. Lastly, the result of the third transformation can then undergo a fourth transformation based on the fourth user input alpha-numeric input “T” 564, which affiliates with alpha-numeric information 205′ and color transformation 203′ and shape transformation 201′, causing shape transformation 656 and color change 658 for the object, at step 412.

In exemplary embodiments, the initial virtual object can based on any reasonable object such as, but not limited to, an arbitrary geometrically shaped object, artwork, a commercial object, consumer electronic device, key fob, picture frame, household item, and/or any object capable of having a virtual object based on it. In further exemplary embodiments, the initial virtual object can be based on or actually be a virtual object, such as, but not limited to, an avatar, an object affiliated with a user, and/or any reasonable virtual object.

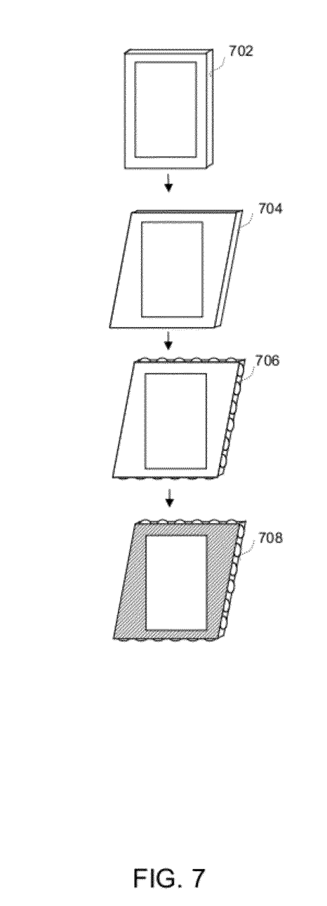

For example, referring to FIG. 7, a virtual shell of a mobile phone based on the required dimensions of a real mobile phone shell can be used to generate a new mobile phone shell in a second configuration that can be used to replace the original mobile phone shell. Similar to above, the shell of a mobile phone can undergo a plurality of transformations, for example, starting as an initial object 702, undergoing a first transformation 704, a second transformation 706, and a final transformation 708. It will be understood that any quantity of transformation can occur. For ease, at times, only three or four transformation are discussed. This is merely for ease and is in no way meant to be a limitation.

In exemplary embodiments, objects can be transformed and/or generated such that they are personalized to an individual, a company, and/or to provide reference to a phrase, date, and/or any other alpha-numeric input.

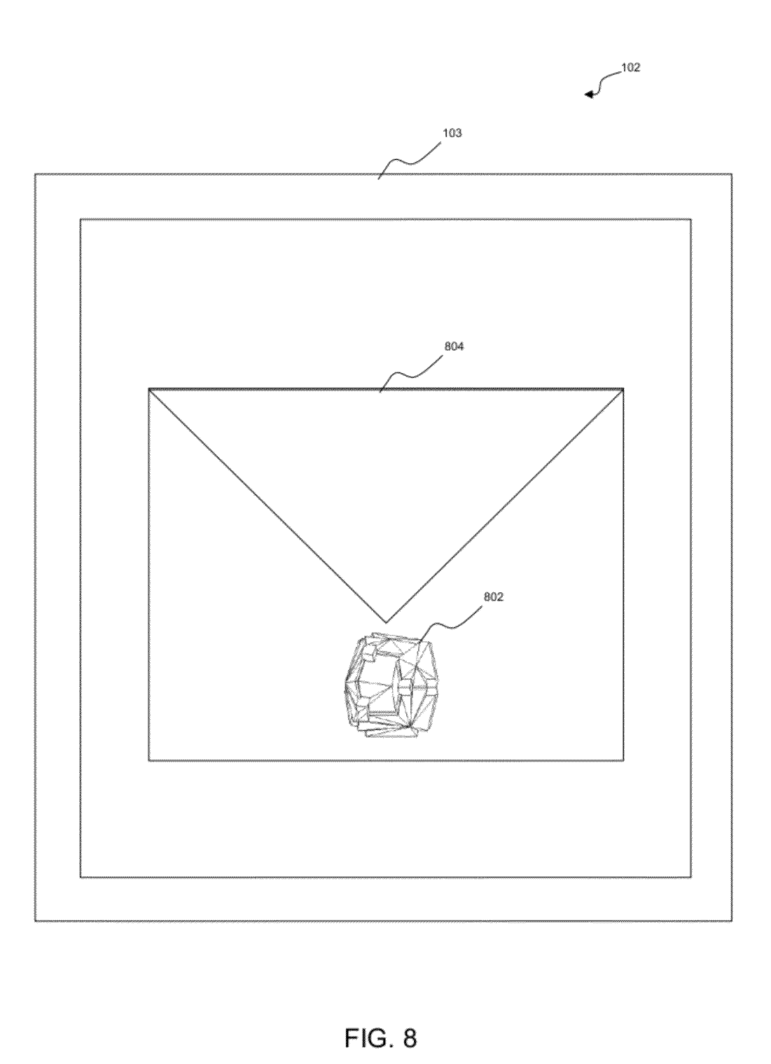

Referring to FIG. 8, in exemplary embodiments, the virtual object in a second configuration can be used as identification. For example, as shown, virtual object 802 is shown with an incoming email 804 on a graphical user interface 103 of user device 102 notifying the recipient that the email is from Tim. As another example, a user can use a virtual object affiliated with them as a pass code for entrance to a website, as a symbol of their name, as a symbol affiliated with a corporation, and/or any reasonable form of identification.

Now that exemplary embodiments of the present disclosure have been shown and described in detail, various modifications and improvements thereon will become readily apparent to those skilled in the art.

What is claimed is:

1. A method for transforming an object based on user input information, comprising:
receiving a user input alpha-numeric input information;
storing, in at least one processor readable memory, the user input alpha-numeric input information and correlating, using an algorithm, the user input alpha-numeric information with at least one of shape and color transformations; and
processing, using at least one processor, the alpha-numeric inputs and the algorithm to transform at least one of the shape and the color of the virtual object from a first configuration to a second configuration.

2. The method of claim 1, further comprising:
generating, using at least one object generating system, a tangible physical object based on the second configuration of the virtual object.

3. The method of claim 1, wherein the alpha-numeric input information includes at least one of the alpha-numeric letters A through Z of the Latin and Roman alphabet and the Arabic numerals 0 through 9.

4. The method of claim 1, wherein each consecutive user input alpha-numeric input into the algorithm causes consecutive transformations of the virtual object such that the previous transformation is used in the next consecutive transformation.

5. The method of claim 1, wherein the alpha-numeric information is a user's name.

6. The method of claim 1, wherein the virtual object having a first shape is cuboid.

7. The method of claim 1, where the virtual object having a first shape is any three-dimensional shape capable of being manipulating using alpha-numeric inputs.

8. The method of claim 7, wherein the three-dimensional shape is that of a consumer product.

9. The method of claim 1, wherein the tangible physical object is generated using at least one of stereo-lithography, 3-D printing, and direct laser sintering.

10. The method of claim 1, wherein the virtual object is an avatar.

11. The method of claim 1, wherein the new shaped physical object is for at least one of an identification and pass code.

12. A system for transforming an object based on user input information, comprising:
at least one of a communications portal and user interface for receiving a user input alpha-numeric input information;
an at least one processor readable memory for storing the user input alpha-numeric input information and for storing an algorithm that correlates the user input alpha-numeric input information to at least one of shape and color transformations; and
an at least one processor for accessing and processing the user input alpha-numeric input information and an algorithm for transforming at least one of the shape and color of the virtual object from a first configuration to a second configuration.

13. The system of claim 12, further comprising:
an at least one object generating system for generating a tangible physical object based on the second configuration of the virtual object.

14. The system of claim 12, wherein the alpha-numeric input information includes are at least one of the alpha-numeric letters A through Z of the Latin and Roman alphabet and the Arabic numerals 0 through 9.

15. The system of claim 12, wherein each consecutive user input alpha-numeric input into the algorithm causes consecutive transformations of the virtual object such that the previous transformation is used in the next consecutive transformation.

16. The system of claim 12, wherein the alpha-numeric input information is a user's name.

17. The system of claim 12, wherein the virtual object having a first shape is at least one of a cuboid, a consumer product, and an avatar.

18. The system of claim 12, where the virtual object having a first shape is any three-dimensional shape capable of being manipulating using alpha-numeric inputs.

19. The system of claim 12, wherein the system is further comprising at least one of:
a stereo-lithography machine;
3-D printing system; and
direct metal laser sintering system.

20. The system of claim 12, wherein the new shaped physical object is for at least one of an identification and pass code.
